(19) United States
(12) Patent Application Publication
(10) Pub. No.: US 2019/0121005 A1
(43) Pub. Date: Apr. 25, 2019

(54) IMAGING DEVICE AND FILTER

(71) Applicant: SHARP KABUSHIKI KAISHA, Sakai City, Osaka (JP)

(72) Inventor: MASAHIRO HASEGAWA, Sakai City (JP)

(73) Assignee: SHARP KABUSHIKI KAISHA, Sakai City, Osaka (JP)

(21) Appl. No.: 16/309,094

(22) PCT Filed: Mar. 16, 2017
(86) PCT No.: PCT/JP2017/010708

§ 371 Date: Dec. 11, 2018

(30) Foreign Application Priority Data
Jun. 17, 2016 (JP) 2016-121185

(51) Int. Cl. G02B 5/20; G03B 11/00; H04N 9/73

(52) U.S. Cl. CPC G02B 5/208; G03B 13/36; H04N 9/735; G03B 11/00

(57) ABSTRACT

The size of a device can be decreased, a foreign substance is inhibited from being seen in a captured image, and more than one kind of image, that is, a visible-light image and a near-infrared-light image can be captured singly by the device. An imaging device includes an imaging element that captures an image of an object formed by light that passes through an optical system, and a signal-reading portion that reads an image signal from the imaging element, and a filter portion that is disposed on an optical axis of the optical system. The filter portion includes a visible-light-shielding portion that obstructs visible light, and a near-infrared-light-shielding portion that obstructs near-infrared light. The position of the filter portion relative to the imaging element is fixed.

### TECHNICAL FIELD

The present invention relates to an imaging device that captures an image of an object formed by light that passes through an optical system, and a filter for use in the imaging device.

### BACKGROUND ART

In recent years, various personal authentication methods have been proposed so as to protect, from unauthorized access, important information such as personal information a person does not want others to know. Among these methods, techniques of authenticating a person by using information unique to every individual organism such as a fingerprint pattern or an iris pattern are referred to as biometrics authentication techniques, which have been put into practical use in a wide range of applications from a large scale apparatus such as an entry and exit management apparatus of the related art to a small, personal device such as a recent cellular phone device.

One of the biometrics authentication techniques is known as an iris authentication technique in which an iris of an organism is photographed, an image thereof (referred below to as an iris image) is coded to obtain authentication information usable for authentication, which is compared to and collated with authentication information recorded in advance for individual authentication. In recent years, the iris authentication technique has been put into practical use as a highly reliable authentication technique because of a low false rejection rate and a low false acceptance rate in addition to a low cost of an apparatus. In such a technique, a method of coding the iris pattern is well known, and it is also well known that irradiating an eye with near-infrared light is effective to photograph the iris pattern in clear contrast.

Regarding an example of a small information apparatus that is equipped with an iris authentication device, a technique is, for example, proposed in which theft is prevented when a function such as an online shopping function is performed by equipping a cellular phone device with an iris authentication device for iris authentication. According to such a technique, a device (referred to below as an iris imaging device) proposed for capturing an iris image for iris authentication also includes a digital camera function such as a function that a typical cellular phone device has, and enables iris authentication as needed while a user uses the digital camera function of the cellular phone device in normal use.

According to the above technique, a visible-light-cutting filter is used for photographing the iris image, and a near-infrared-light-cutting filter is used for photographing, for example, a normal scene. A user switches between the filters manually or electrically for imaging to achieve both of the above functions.

Specifically, as illustrated in FIG. 12(a), PTL 1 discloses a lens unit 20 that is equipped with two kinds of lenses of a telephoto lens 21 and a wide angle lens 22, two kinds of filters of a visible-light-cutting filter 23 and an infrared-light-cutting filter 24, and a mechanism that manually slides the lens unit 20 in the direction of an arrow A with respect to a solid-state imaging element 12.

As illustrated in FIGS. 12(b) and 12(c), PTL 2 discloses a filter portion 3 that includes two kinds of filters of a near-infrared-light-cutting portion 31 and a visible-light-cutting portion 32, and a driving mechanism that slides the filter portion 3 in the top-bottom direction of the paper with respect to an imaging element 4 by using an actuator 6.

### CITATION LIST

### Patent Literature

PTL 1: Japanese Unexamined Patent Application Publication No. 2003-256819 (published Sep. 12, 2003)

PTL 2 Japanese Unexamined Patent Application Publication No. 2006-48266 (published Feb. 16, 2006)

### SUMMARY OF INVENTION

### Technical Problem

In recent years, cellular phone devices, PCs (Personal Computers), and tablet terminals have become thinner and smaller. However, in the case where the mechanism that slides the lens unit 20 disclosed in PTL 1 or the filter portion 3 disclosed in PTL 2 is disposed in a device, there is a problem in that it is difficult for the device to have a decreased size. In the case where the driving mechanism as disclosed in PTL 2 is disposed in a device, there is a problem in that a foreign substance is seen in a captured image due to dust from the driving mechanism, and a failure is found in a market.

The present invention has been accomplished in view of the above problems, and an object of the present invention is to provide an imaging device or the like that has a decreased size, that inhibits a foreign substance from being seen in a captured image, and that can capture more than one kind of image, that is, a visible-light image and a near-infrared-light image by the single device.

### Solution to Problem

To solve the above problems, an imaging device according to an aspect of the present invention includes an imaging element that captures an image of an object formed by light that passes through an optical system, a signal-reading portion that reads an image signal from the imaging element, and a filter portion that is disposed on an optical axis of the optical system. The filter portion includes a visible-light-shielding portion that obstructs visible light, and a near-infrared-light-shielding portion that obstructs near-infrared light. The imaging element includes a first imaging element on which light that passes through the visible-light-shielding portion forms an image, and a second imaging element on which light that passes through the near-infrared-light-shielding portion forms an image. The signal-reading portion is configured to read the image signal separately from the first imaging element and the second imaging element. A position of the filter portion relative to the imaging element is fixed.

To solve the above problems, a filter according to an aspect of the present invention is a filter for use in an imaging device. The filter includes a visible-light-shielding portion that obstructs visible light, and a near-infrared-light-shielding portion that obstructs near-infrared light. A light-shielding member that obstructs the visible light and the near-infrared light is disposed on a boundary between the visible-light-shielding portion and the near-infrared-light-shielding portion.

### Advantageous Effects of Invention

An imaging device according to an aspect of the present invention has a decreased size, inhibits a foreign substance from being seen in a captured image, and can capture more than one kind of image, that is, a visible-light image and a near-infrared-light image by the single device.

A filter according to an aspect of the present invention can inhibit, for example, a flare from occurring due to reflection from a surface on the boundary between the visible-light-shielding portion and the near-infrared-light-shielding portion.

### BRIEF DESCRIPTION OF DRAWINGS

FIG. 1 is a sectional view of the structure of a main part of an imaging device according to Embodiment 1 of the present invention.

FIG. 2 illustrates the relationship between an optical path on which light passes through an optical system and an imaging element of the imaging device.

FIG. 3 illustrates an example of an image captured by the imaging device.

FIG. 4 illustrates a method of manufacturing a visible-light-shielding portion according to Embodiment 1 of the present invention.

FIG. 5 illustrates a method of manufacturing a near-infrared-light-shielding portion according to Embodiment 1 of the present invention.

FIG. 6(a) is a sectional view of the structure of a filter portion according to Embodiment 1 of the present invention, and FIG. 6(b) is a sectional view of the structure of a filter portion according to a modification.

FIG. 7 illustrates a method of manufacturing the imaging device according to Embodiment 1 of the present invention.

FIG. 8 illustrates a method of manufacturing a filter portion according to Embodiment 2 of the present invention.

FIG. 9 illustrates an imaging device according to Embodiment 3 of the present invention with an autofocus mechanism mounted on a holder.

FIG. 10 is a sectional view of the structure of a main part of an imaging device according to Embodiment 3 of the present invention.

FIG. 11 is a sectional view of the structure of a main part of an imaging device according to Embodiment 4 of the present invention.

FIG. 12 illustrates the related art.

### DESCRIPTION OF EMBODIMENTS

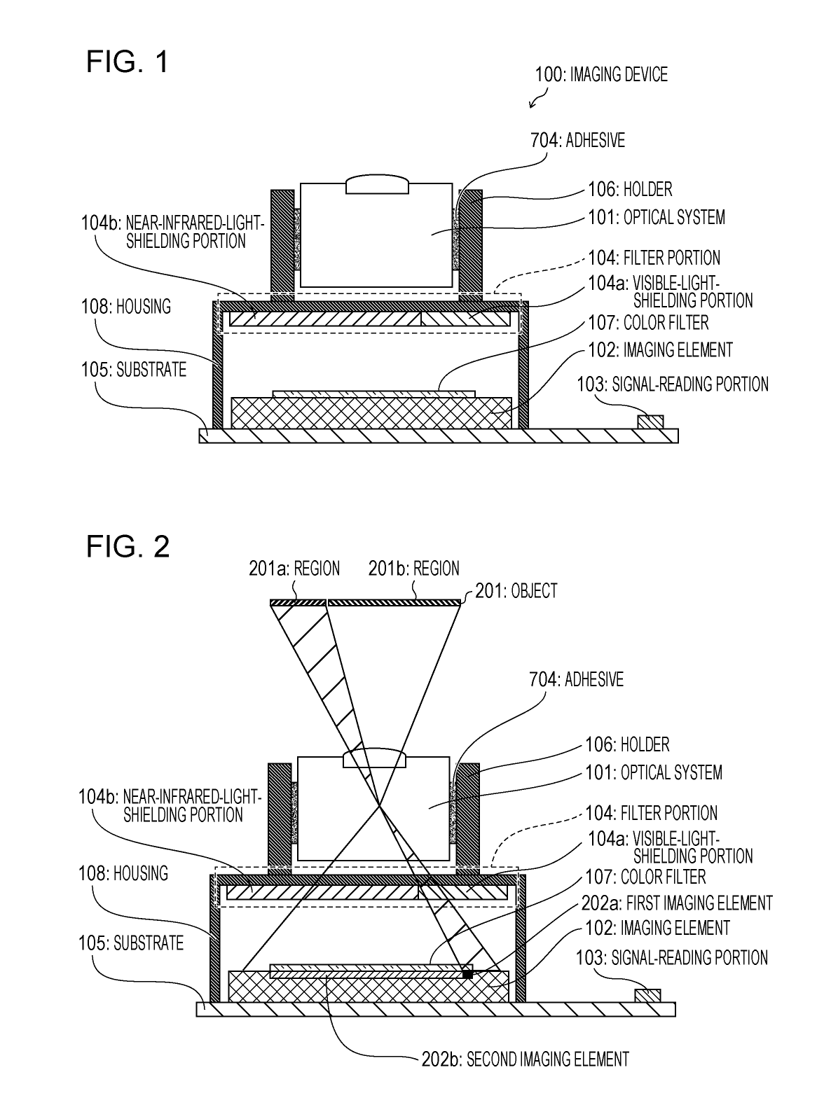

Embodiments of the present invention will be described below with reference to FIG. 1 to FIG. 11. For convenience of description, a component having a function like to the function of a component described for a specific item is designated by a like reference character, and a description thereof is omitted.

### Embodiment 1

FIG. 1 is a sectional view of the structure of a main part of an imaging device 100 according to Embodiment 1 of the present invention. As illustrated in FIG. 1, the imaging device 100 includes an optical system 101, an imaging element 102, a signal-reading portion 103, a filter portion (filter) 104, a substrate 105, a holder 106, a color filter 107, and a housing 108.

The imaging device 100 is an imaging device that is used for personal photograph, particularly in a cellular phone device with a camera, a PC with a camera, and other devices. Also, the imaging device 100 is an imaging device that has an authentication function such as an iris authentication device that uses an ocular image photographed for personal authentication.

The optical system 101 causes an optical image of an object to be formed on a first imaging element 202a and a second imaging element 202b of the imaging element 102 as described later (see FIG. 2). The optical system 101 according to the present embodiment has a fixed focal length and the focal length of the optical system 101 does not change. This eliminates the need to include a focus adjustment mechanism (autofocus mechanism 901) described later and enables the size of the device to be decreased.

The imaging element 102 captures the image of the object formed by light that passes through the optical system 101. The imaging element 102 includes the first imaging element 202a and the second imaging element 202b as described later. Light that passes through a visible-light-shielding portion 104a forms an image on the first imaging element 202a. Light that passes through a near-infrared-light-shielding portion 104b forms an image on the second imaging element 202b. The imaging element 102 includes an imaging element having a high pixel number of 5 M or more. This enables a region for iris authentication to be decreased without using a special telephoto lens.

The signal-reading portion 103 reads the image signal separately from the first imaging element 202a and the second imaging element 202b. The signal-reading portion 103 is disposed on the substrate 105 outside the housing 108.

The filter portion 104 is disposed on the optical axis of the optical system 101 and includes the visible-light-shielding portion 104a that obstructs visible light and the near-infrared-light-shielding portion 104b that obstructs near-infrared light. The visible-light-shielding portion 104a may obstruct light having a wavelength other than a wavelength of 800 nm to 850 nm. In general, a wavelength near 810 nm is a wavelength at which an iris pattern can be efficiently authenticated even when there are different colors of eyes (people from different countries have various colors of eyes). Accordingly, the above structure enables the iris pattern to be efficiently authenticated even when there are different colors of eyes.

The imaging element 102 is disposed on the substrate 105. The color filter 107 is disposed on the surface of the imaging element 102 on which the light forms an image. The color filter 107 typically includes a color filter of three primary colors (RGB) for each sub-pixel of an image (pixel) to display a multicolored image captured by the imaging element 102.

A part of the substrate 105 on which the imaging element 102 is disposed is covered by the housing 108. The filter portion 104 is disposed on an upper, inner wall surface of the housing 108. The position of the filter portion 104 relative to the imaging element 102 is fixed. That is, the imaging device 100 is designed such that the device does not need to contain a special driving mechanism that changes the position of the filter portion 104 relative to the imaging element 102. Accordingly, the imaging device 100 has a decreased size and can inhibit a foreign substance from being seen in the captured image.

The signal-reading portion 103 of the imaging device 100 reads the image signal separately from the first imaging element 202a and the second imaging element 202b. Light that passes through the visible-light-shielding portion 104a forms an image on the first imaging element 202a. Light that passes through the near-infrared-light-shielding portion 104b forms an image on the second imaging element 202b. Accordingly, a near-infrared-light image is captured from the first imaging element 202a, and a visible-light image is captured from the second imaging element 202b. Thus, more than one kind of image, that is, the visible-light image and the near-infrared-light image can be captured by the single device. Thus, the size of the device can be decreased, a foreign substance is inhibited from being seen in the captured image, and plural kinds of images of the visible-light image and the near-infrared-light image can be captured by the single device.

As illustrated in FIG. 2, the imaging element 102 captures the image of an object 201. The image captured is read by the signal-reading portion 103. The imaging element 102 includes the first imaging element 202a on which light that passes through the visible-light-shielding portion 104a forms an image, and the second imaging element 202b on which light that passes through the near-infrared-light-shielding portion 104b forms an image. At this time, a region 201a of the object 201 is photographed by the first imaging element 202a, and a region 201b of the object 201 other than the region 201a is photographed by the second imaging element 202b. Accordingly, the visible-light-shielding portion 104a is disposed in a light region in which the region 201a of the object 201 is photographed, and the near-infrared-light-shielding portion 104b is disposed in a light region in which the region 201b of the object 201 is photographed. This enables two kinds of images to be captured. Consequently, the visible-light image can be captured from the second imaging element 202b while the near-infrared-light image is captured from the first imaging element 202a. The imaging element 102 can output different desired regions.

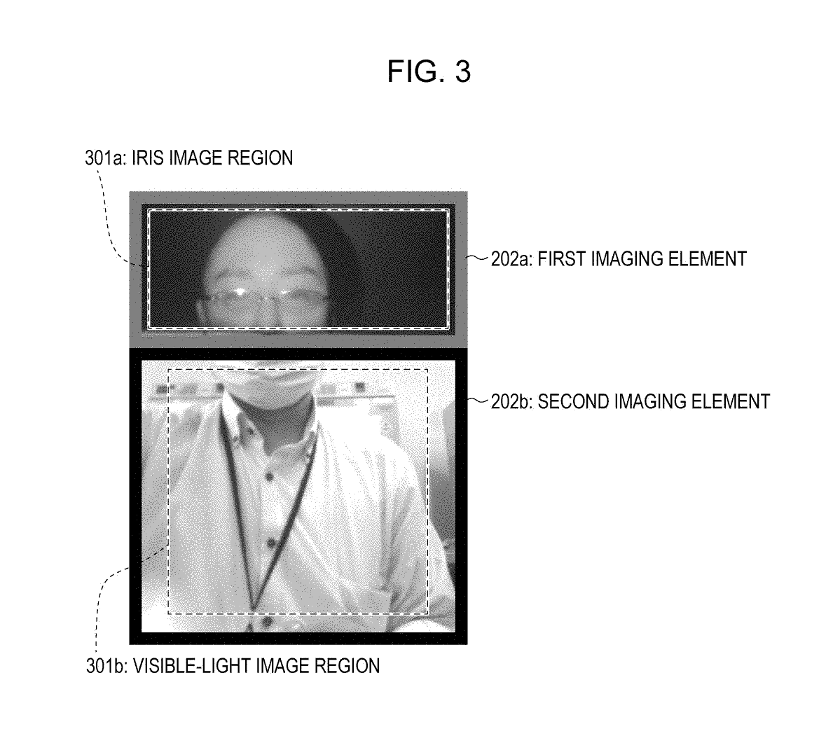

As illustrated in FIG. 3, in the case where the imaging device is configured so that an iris image region 301a is outputted from the first imaging element 202a, and a visible-light image region 301b is outputted from the second imaging element 202b, a captured visible-light image and a captured iris image (near-infrared-light image) can be separately outputted by the single imaging device.

Thus, the single imaging device 100 can achieve two kinds of purposes such that the captured visible-light image and the captured iris image can be separately outputted by the single device. Accordingly, there is no need to prepare two kinds of imaging devices corresponding to the images or to prepare a movement member that enables the filter portion 104 to move, and the purposes can be achieved with a small space. It is only necessary that there is the single imaging device. There is no need to prepare two kinds of imaging devices corresponding to the images or to prepare a mechanism that moves the filter portion 104, and the purposes can be achieved at a low cost. The size of each image can desirably be set by changing the sizes of the visible-light-shielding portion 104a and the near-infrared-light-shielding portion 104b of the filter portion 104. The optical system 101 includes no driving portion. Accordingly, no dust is generated, and a high quality imaging device is provided.

### (Method of Manufacturing Filter Portion 104)

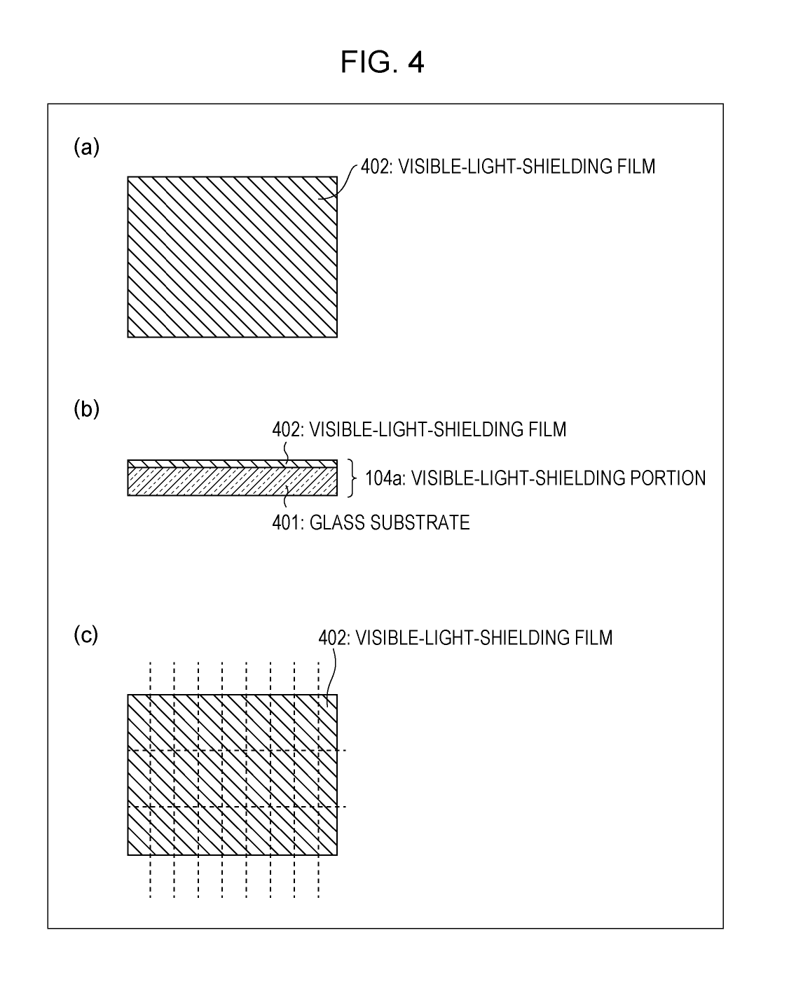

A method of manufacturing the filter portion 104 is described with reference to FIG. 4 to FIG. 6. FIG. 4 illustrates a method of manufacturing the visible-light-shielding portion 104a of the filter portion 104 according to Embodiment 1 of the present invention.

As illustrated in FIGS. 4(a) and 4(b), a visible-light-shielding film 402 is formed on a glass substrate 401. A forming method may be, for example, a typical sputtering method or vapor deposition method. Visible light is obstructed. For example, a transmission wavelength range is 800 nm to 850 nm.

Subsequently, as illustrated in FIG. 4(c), a filter that includes the visible-light-shielding film 402 formed on the glass substrate 401 is cut into a desirable size. A cutting method may be a normal blade dicing method or laser dicing method.

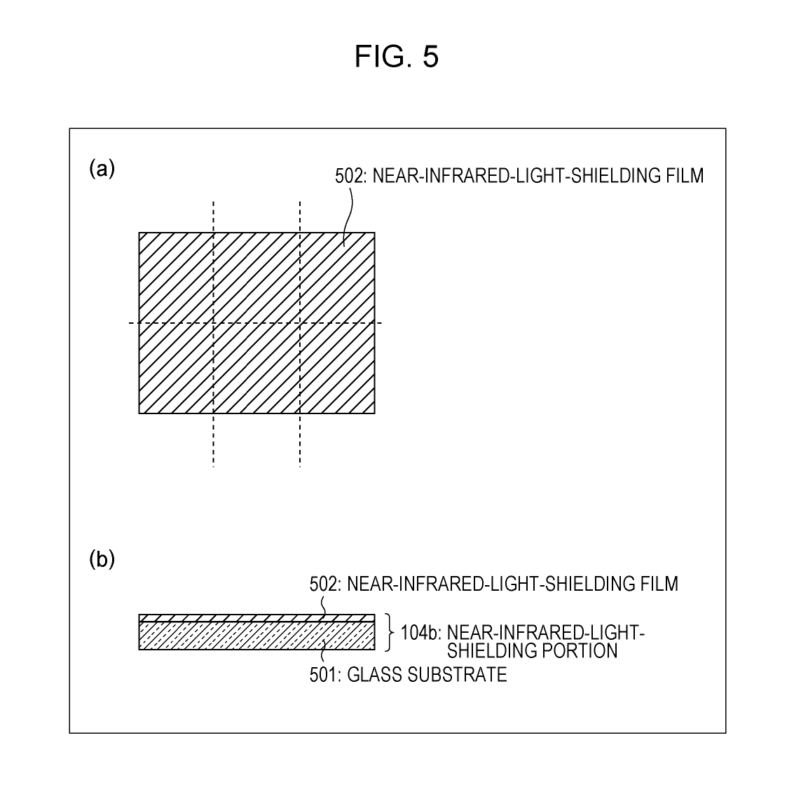

FIG. 5 illustrates a method of manufacturing the near-infrared-light-shielding portion 104b of the filter portion 104 according to Embodiment 1 of the present invention. As illustrated in FIGS. 5(a) and 5(b), a filter that includes a near-infrared-light-shielding film 502 formed on a glass substrate 501 is cut into a desirable size. Near-infrared light is obstructed. For example, a transmission wavelength range is 400 nm to 650 nm.

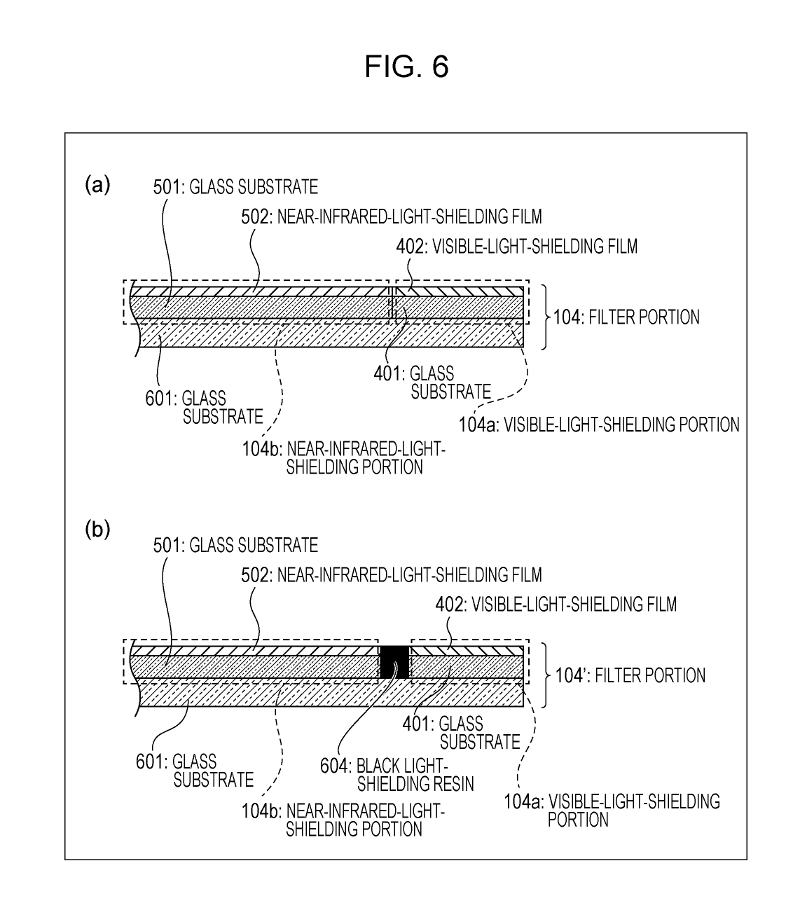

Subsequently, as illustrated in FIG. 6(a), the visible-light-shielding portion 104a and the near-infrared-light-shielding portion 104b are bonded to each other on a glass substrate 601 to form the filter portion 104 desirably.

### [Modification]

The structure of a filter portion (filter) 104′ according to a modification is described with reference to FIG. 6(b). As illustrated in FIG. 6(b), a light-shielding member (black light-shielding resin 604) that obstructs visible light and near-infrared light may be disposed on the boundary between the visible-light-shielding portion 104a and the near-infrared-light-shielding portion 104b. That is, the black light-shielding resin 604 may be disposed between the glass substrate (first glass substrate) 401 and the glass substrate (second glass substrate) 501. This inhibits, for example, a flare from occurring due to reflection from the surface (glass surface of a joint) on the boundary between the visible-light-shielding portion 104a and the near-infrared-light-shielding portion 104b.

### (Method of Manufacturing Imaging Device 100)

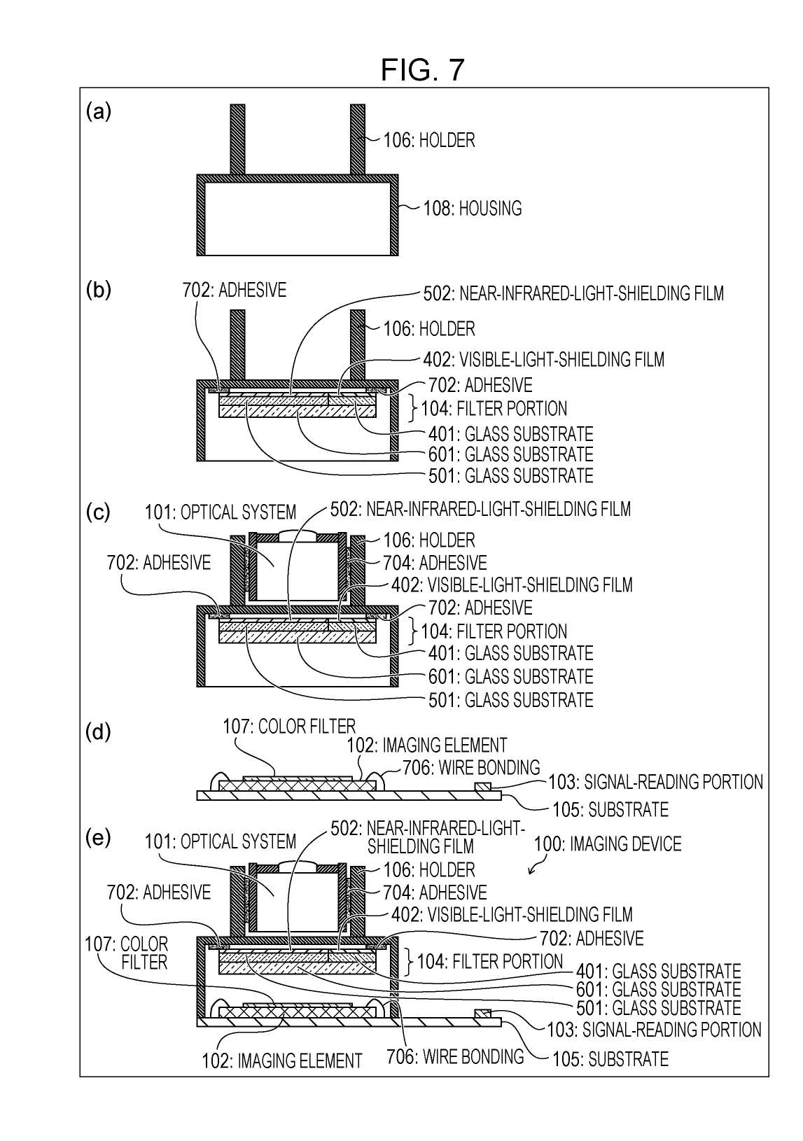

A method of manufacturing the imaging device 100 according to Embodiment 1 of the present invention is described with reference to FIG. 7. FIG. 7 illustrates the method of manufacturing the imaging device 100. FIG. 7(a) illustrates the holder 106 that holds the optical system 101 and the housing 108 that holds the filter portion 104.

As illustrated in FIG. 7(b), the filter portion 104 is bonded to an upper, inner wall surface of the housing 108 with an adhesive 702 in a conventional manner. Subsequently, as illustrated in FIG. 7(c), the optical system 101 is bonded to the holder 106 with an adhesive 704 in a conventional manner.

Subsequently, as illustrated in FIG. 7(d), the substrate 105 on which the signal-reading portion 103 (connector) is mounted is prepared, the imaging element 102 (sensor) is die-bonded in a typical manner, and wire bonding 706 is performed to connect the substrate 105 and the imaging element 102 to each other.

Subsequently, a member (referred to as a fixed focus optical unit) illustrated in FIG. 7(c) is bonded to the substrate 105 illustrated in FIG. 7(d) to manufacture the imaging device 100 illustrated in FIG. 7(e).

### Embodiment 2

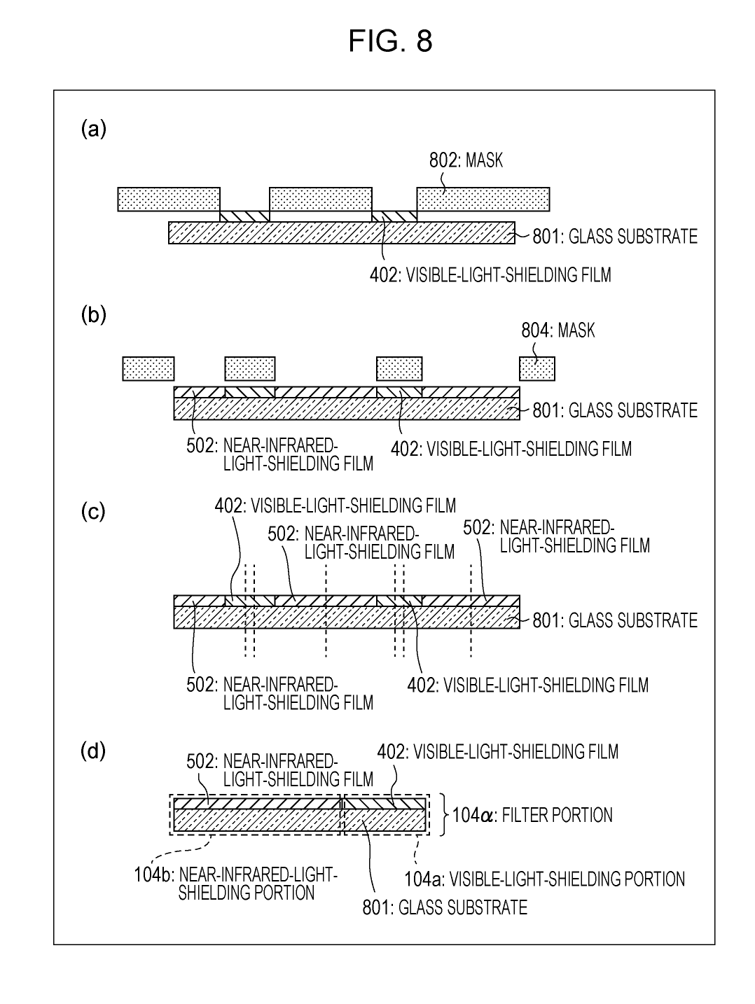

A method of manufacturing a filter portion (filter) 104α according to Embodiment 2 of the present invention is described with reference to FIG. 8. FIG. 8 illustrates the method of manufacturing the filter portion 104α.

As illustrated in FIG. 8(a), the visible-light-shielding film 402 is formed at a desirable position on the glass substrate 801 with a mask 802. Subsequently, as illustrated in FIG. 8(b), the near-infrared-light-shielding film 502 is formed with a mask 804 having an opposite pattern to that of the mask 802. A method of forming these films may be a typical sputtering method or vapor deposition method.

Subsequently, as illustrated in FIG. 8(c), the glass substrate 801 is cut into an appropriate size in a typical manner. Consequently, as illustrated in FIG. 8(d), the filter portion 104α is desirably formed. The filter portion 104α is used to manufacture the imaging device according to the present embodiment by the manufacturing method illustrated in FIG. 7.

The filter portion 104α includes the visible-light-shielding film 402 and the near-infrared-light-shielding film 502 that are directly formed on the single glass substrate 801. Accordingly, the thickness of the filter portion 104α can be less than that of the filter portion 104 illustrated in FIG. 6(a).

### Embodiment 3

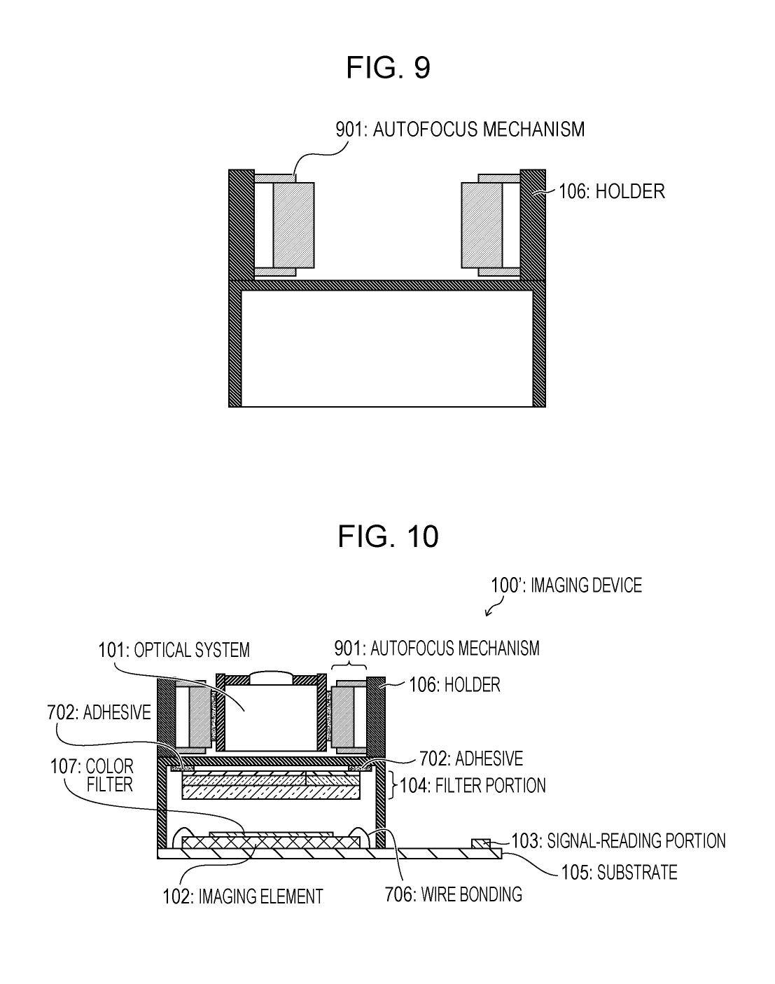

An imaging device 100′ according to Embodiment 3 of the present invention is described with reference to FIG. 9 and FIG. 10. FIG. 9 illustrates the holder 106 on which the autofocus mechanism 901 is mounted. The autofocus mechanism 901 may be a typical VCM (Voice Coil Motor) mechanism or a typical ball guide mechanism. The holder 106 illustrated in FIG. 9 is used to manufacture the imaging device 100′ that includes the autofocus mechanism 901 illustrated in FIG. 10 by the same method as those according to the above Embodiments 1 and 2. This inhibits the captured image from being out of focus.

### Embodiment 4

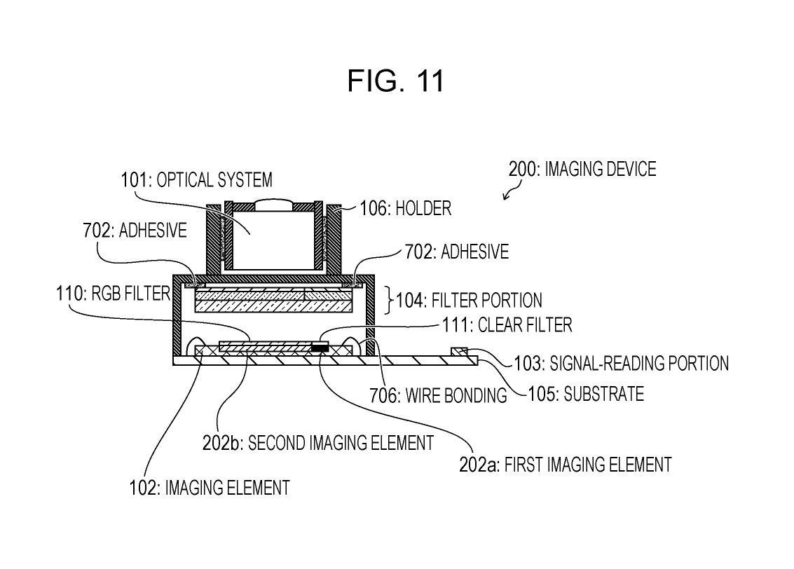

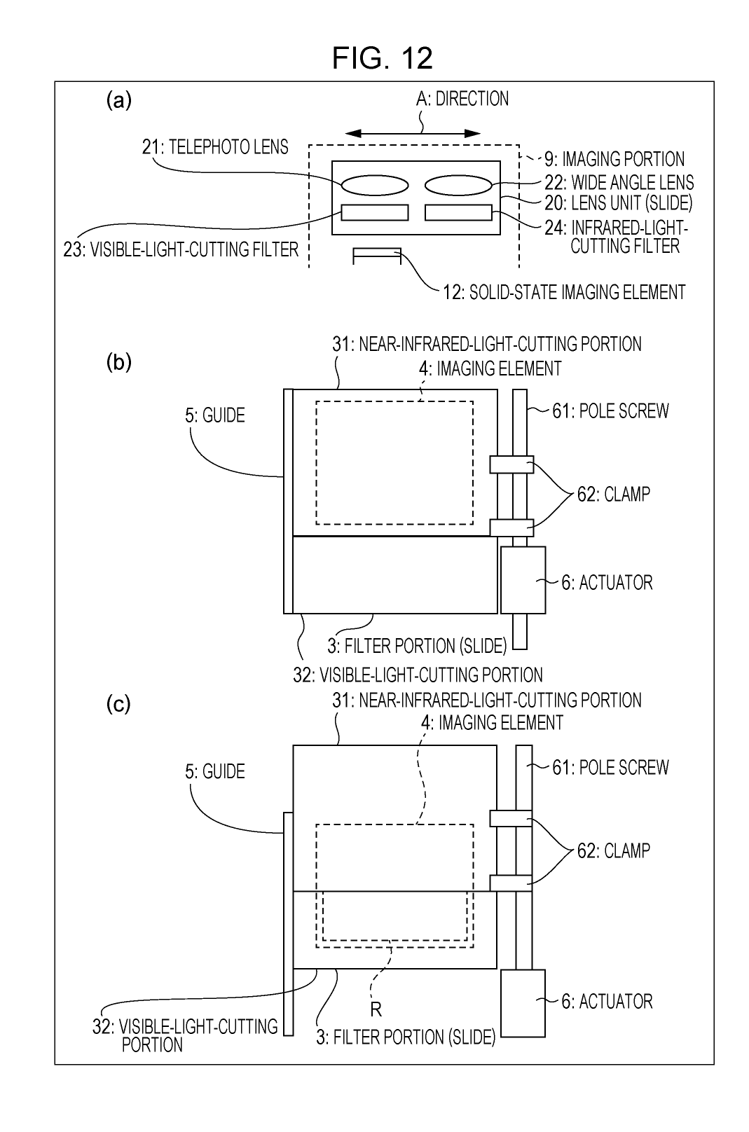

FIG. 11 is a sectional view of the structure of a main part of an imaging device 200 according to Embodiment 4 of the present invention. In the imaging device 200 according to the present embodiment, a clear filter 111 through which all light passes is disposed on the surface (visible-light-shielding region) of the first imaging element 202a on which the light forms an image, and a RGB filter 110 (RGB color filter) is disposed on the surface (near-infrared-light-shielding region) of the second imaging element 202b on which the light forms an image. Since a filter on the imaging element 102 for the near-infrared-light-shielding region and a filter on the imaging element 102 for the visible-light-shielding region are separately provided, the use of the RGB filter 110 enables the near-infrared-light-shielding region to capture a typical visible-light image (color image). In addition, the use of the clear filter 111 enables the visible-light-shielding region to capture a high quality iris image with higher sensitivity. That is, the above structure enables the near-infrared-light image to be clear and enables the visible-light image to be a color image.

### CONCLUSION

An imaging device according to Aspect 1 of the present invention includes the imaging element (102) that captures the image of the object formed by light that passes through the optical system (101), the signal-reading portion (103) that reads the image signal from the imaging element, and the filter portion (104) that is disposed on the optical axis of the optical system. The filter portion includes the visible-light-shielding portion (104a) that obstructs visible light, and the near-infrared-light-shielding portion (104b) that obstructs near-infrared light. The imaging element includes the first imaging element (202a) on which light that passes through the visible-light-shielding portion forms an image, and the second imaging element (202b) on which light that passes through the near-infrared-light-shielding portion forms an image. The signal-reading portion is configured to read the image signal separately from the first imaging element and the second imaging element. The position of the filter portion relative to the imaging element is fixed.

With the above structure, the position of the filter portion relative to the imaging element is fixed. That is, the device does not need to contain a special driving mechanism that changes the position of the filter portion relative to the imaging element. Accordingly, the device has a decreased size and can inhibit a foreign substance from being seen in the captured image.

With the above structure, the signal-reading portion reads the image signal separately from the first imaging element and the second imaging element. Light that passes through the visible-light-shielding portion forms an image on the first imaging element. Light that passes through the near-infrared-light-shielding portion forms an image on the second imaging element. Accordingly, the near-infrared-light image is captured from the first imaging element, and the visible-light image is captured from the second imaging element. Thus, more than one kind of image, that is, the visible-light image and the near-infrared-light image can be captured by the single device.

Thus, the size of the device can be decreased, a foreign substance is inhibited from being seen in the captured image, and plural kinds of images of the visible-light image and the near-infrared-light image can be captured by the single device.

In an imaging device according to Aspect 2 of the present invention, the light-shielding member (black light-shielding resin 604) that obstructs the visible light and the near-infrared light may be disposed on the boundary between the visible-light-shielding portion and the near-infrared-light-shielding portion in Aspect 1. With the above structure, a flare, for example, can be inhibited from occurring due to reflection from the surface on the boundary between the visible-light-shielding portion and the near-infrared-light-shielding portion.

In an imaging device according to Aspect 3 of the present invention, the visible-light-shielding portion may include the visible-light-shielding film (402) that is formed on the first glass substrate (glass substrate 401), the near-infrared-light-shielding portion may include the near-infrared-light-shielding film (502) that is formed on the second glass substrate (glass substrate 501), and the light-shielding member may be disposed between the first glass substrate and the second glass substrate in Aspect 2. With the above structure, a flare, for example, can be inhibited from occurring due to reflection from the glass surface on the boundary between the visible-light-shielding portion and the near-infrared-light-shielding portion.

In an imaging device according to Aspect 4 of the present invention, the clear filter through which all light passes may be disposed on the surface of the first imaging element on which the light forms an image, and the RGB color filter may be disposed on the surface of the second imaging element on which the light forms an image in any one of Aspects 1 to 3. The above structure enables the near-infrared-light image to be clear and enables the visible-light image to be a color image.

In an imaging device according to Aspect 5 of the present invention, the visible-light-shielding portion may obstruct light having a wavelength other than a wavelength of 800 nm to 850 nm in any one of Aspects 1 to 4. In general, a wavelength near 810 nm is a wavelength at which an iris pattern can be efficiently authenticated even when there are different colors of eyes (people from different countries have various colors of eyes). Accordingly, the above structure enables the iris pattern to be efficiently authenticated even when there are different colors of eyes.

In an imaging device according to Aspect 6 of the present invention, the optical system may have a fixed focal length in any one of Aspects 1 to 5. This structure eliminates the need to include a focus adjustment mechanism and enables the size of the device to be decreased.

In an imaging device according to Aspect 7 of the present invention, the optical system may include the autofocus mechanism (901) in any one of Aspects 1 to 5. This structure inhibits the captured image from being out of focus.

A filter according to Aspect 8 of the present invention is a filter (filter portion 104′) for use in an imaging device. The filter includes the visible-light-shielding portion (104a) that obstructs visible light, and the near-infrared-light-shielding portion (104b) that obstructs near-infrared light. The light-shielding member (black light-shielding resin 604) that obstructs the visible light and the near-infrared light is disposed on the boundary between the visible-light-shielding portion and the near-infrared-light-shielding portion. With the above structure, a flare, for example, can be inhibited from occurring due to reflection from the surface on the boundary between the visible-light-shielding portion and the near-infrared-light-shielding portion.

In a filter according to Aspect 9 of the present invention, the visible-light-shielding portion may include the visible-light-shielding film (402) that is formed on the first glass substrate (glass substrate 401), the near-infrared-light-shielding portion may include the near-infrared-light-shielding film (502) that is formed on the second glass substrate (glass substrate 501), and the light-shielding member may be disposed between the first glass substrate and the second glass substrate in Aspect 8. With the above structure, a flare, for example, can be inhibited from occurring due to reflection from the glass surface on the boundary between the visible-light-shielding portion and the near-infrared-light-shielding portion.

### Another Expression of Present Invention

The present invention can also be expressed as follows. That is, an imaging device according to an aspect of the present invention includes an optical system, an imaging element that captures an image of an object formed by light that passes through the optical system, a signal-reading portion that reads an image signal from a predetermined region of the imaging element, and a filter portion that includes a visible-light-shielding portion that obstructs visible light and a near-infrared-light-shielding portion that obstructs near-infrared light, and that is disposed on an optical axis of the optical system. The visible-light-shielding portion and the near-infrared-light-shielding portion interfere with at least part of an optical path region of the imaging element. The signal-reading portion reads the image signals at respective portions on which light that passes through the visible-light-shielding portion and the near-infrared-light-shielding portion of the imaging element forms an image.

### Additional Remarks

The present invention is not limited to the above embodiments. Various modifications can be made within the scope of Claims. An embodiment obtained by appropriately combining technical measures disclosed in different embodiments is also included in the technical scope of the present invention. A combination of the technical measures disclosed in the embodiments can form a new technical feature.

### REFERENCE SIGNS LIST

100 imaging device
100′ imaging device
200 imaging device
101 optical system
102 imaging element
103 signal-reading portion
104 filter portion (filter)
104′ filter portion (filter)
104α filter portion (filter)
104a visible-light-shielding portion
104b near-infrared-light-shielding portion
110 RGB filter
111 clear filter
201 object
202a first imaging element
202b second imaging element
401 glass substrate (first glass substrate)
402 visible-light-shielding film
501 glass substrate (second glass substrate)
502 near-infrared-light-shielding film
601 glass substrate
604 black light-shielding resin (light-shielding member)
901 autofocus mechanism

1. An imaging device comprising:
an imaging element that captures an image of an object formed by light that passes through an optical system;
a signal-reading portion that reads an image signal from the imaging element; and
a filter portion that is disposed on an optical axis of the optical system, wherein
the filter portion includes a visible-light-shielding portion that obstructs visible light, and a near-infrared-light-shielding portion that obstructs near-infrared light,
the imaging element includes a first imaging element on which light that passes through the visible-light-shielding portion forms an image, and a second imaging element on which light that passes through the near-infrared-light-shielding portion forms an image,
the signal-reading portion is configured to read the image signal separately from the first imaging element and the second imaging element,
a position of the filter portion relative to the imaging element is fixed, and
a light-shielding member that obstructs the visible light and the near-infrared light is disposed on a boundary between the visible-light-shielding portion and the near-infrared-light-shielding portion.

2. (canceled)

3. The imaging device according to claim 1, wherein
the visible-light-shielding portion includes a visible-light-shielding film that is formed on a first glass substrate,
the near-infrared-light-shielding portion includes a near-infrared-light-shielding film that is formed on a second glass substrate, and
the light-shielding member is disposed between the first glass substrate and the second glass substrate.

4. The imaging device according to claim 1, wherein a clear filter through which all light passes is disposed on a surface of the first imaging element on which light forms an image, and an RGB color filter is disposed on a surface of the second imaging element on which light forms an image.

5. The imaging device according to claim 1, wherein the visible-light-shielding portion obstructs light having a wavelength other than a wavelength of 800 nm to 850 nm.

6. The imaging device according to claim 1, wherein the optical system has a fixed focal length.

7. The imaging device according to claim 1, wherein the optical system includes an autofocus mechanism.

8. A filter for use in an imaging device, the filter comprising:
a visible-light-shielding portion that obstructs visible light; and a near-infrared-light-shielding portion that obstructs near-infrared light, wherein
a light-shielding member that obstructs the visible light and the near-infrared light is disposed on a boundary between the visible-light-shielding portion and the near-infrared-light-shielding portion.

9. The filter according to claim 8, wherein
the visible-light-shielding portion includes a visible-light-shielding film that is formed on a first glass substrate, and the near-infrared-light-shielding portion includes a near-infrared-light-shielding film that is formed on a second glass substrate, and
the light-shielding member is disposed between the first glass substrate and the second glass substrate.
